(19) United States
(12) Patent Application Publication
(10) Pub. No.: US 2006/0109230 A1
(43) Pub. Date: May 25, 2006

(54) Liquid crystal display and driving method thereof

(75) Inventors: Bo-Young An, Suwon-si (KR); Dong-Hwan Kim, Suwon-si (KR); Hyung-Guel Kim, Yongin-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/285,823

(22) Filed: Nov. 23, 2005

(30) Foreign Application Priority Data
Nov. 25, 2004 (KR) 10-2004-0097440

(51) Int. Cl. G09G 3/36

(52) U.S. Cl. 345/98

(57) ABSTRACT

A liquid crystal display may include: a panel assembly provided with a plurality of pixels connected to gate lines and data lines; a signal controller generating a plurality of output control signals on the basis of image data and input control signals from an external MPU; a gate drive circuit generating gate signals for application to the gate lines; a memory performing writing and reading operations in response to predetermined control signals and synchronization signals, wherein the panel assembly comprises a normal mode and a rotated mode, and wherein the number of writing operations is smaller than the number of reading operations and last-inputted data are outputted first when the panel assembly is in the rotated mode.

### BACKGROUND OF THE INVENTION

(a) Field of the Invention

The present invention relates to a liquid crystal display (LCD) and a driving method thereof, and, in particular, to an LCD and a driving method thereof which is capable of displaying an image while rotating a panel assembly.

(b) Description of Related Art

Generally, an LCD includes a liquid crystal (LC) panel assembly having two panels, one provided with pixel electrodes, one provided with common electrodes, and an LC layer with dielectric anisotropy interposed therebetween. The pixel electrodes are arranged in a matrix and are connected to switching elements such as thin film transistors (TFT) to be sequentially applied with a data voltage for a row. The common electrodes cover the entire surface of the upper panel and are supplied with a common voltage Vcom. From a circuit perspective, a pixel electrode, a common electrode, and the LC layer form an LC capacitor, and the LC capacitor together with a switching element connected thereto form a pixel unit. To avoid deterioration of the LC layer from deteriorating due to a one-directional electric field, the polarity of the data voltage is reversed for each frame, for each row or for each dot with respect to the common voltage, or alternatively the polarities of the data voltage and the common voltage are both reversed.

LCDs for a small to medium sized display device used for mobile phones, a so-called dual display device which has panel assemblies at inner and outer sides thereof are being developed. Dual display device include a main panel assembly mounted on the inner side, a subsidiary panel assembly mounted on the outer side, a driving flexible printed circuit film (FPC) provided with signal lines to transmit input signals from external devices, an auxiliary FPC connecting the main panel assembly to the subsidiary panel assembly, and an integration chip which controls the above-described elements.

Additionally, the LCD includes a panel assembly provided with the pixels and display signal lines, for applying a gate-on voltage and a gate-off voltage to gate lines of the display signal lines to turn the switching elements on and off, and data drive circuit applying data voltage to data lines of the display signal lines for application to the pixel via the turned-on switching element.

The integration chip generates control signals and drive signals for controlling the main panel assembly and the subsidiary panel assembly, which is generally mounted as a COG (chip on glass) structure.

The gate drive circuit is implemented as a shift register comprised of a plurality of stages, with an initial stage being supplied with a scanning start signal from an external device, with subsequent stages following the initial stage being supplied with a carry signal, thereby sequentially generating a gate signal.

In the gate drive circuit, there are styles of chip, which are an integrated circuit type and an integration type in which the panel assembly is formed together with the switching element.

Recently, a technique for displaying an image after rotating the panel assembly of the mobile phone has been widely developed. That is, when the panel assembly is rotated (hereinafter referred to as “rotated mode,”) and when not rotated (hereinafter referred to as “normal mode”), the image is reversed in the user's view, and even though it is rotated the image is displayed upright identically to a state in the normal mode. Hereinafter, the upright image is referred to as “original image.”

When the gate drive circuit is integrated on the lateral side of the panel assembly, implementation of the original image for the rotated mode requires a separate gate drive circuit on the other side thereof. As the resolution is higher, spaces exist between signal lines and configuration of circuits is complicated, so it is hard to implement the rotated mode.

Additionally, when the image is displayed in real time at 60 frames/second in the rotated mode, a direction of writing image data to a memory and a direction of reading the image data from the memory collide interfere with each other, resulting in image break-up.

### SUMMARY OF THE INVENTION

An object of the present invention is to provide a liquid crystal display and a driving method thereof that are capable of solving such conventional problems.

A liquid crystal display according to an exemplary embodiment of the present invention includes: a panel assembly provided with a plurality of pixels connected to gate lines and data lines; a signal controller generating a plurality of output control signals on the basis of image data and input control signals from an external MPU; a gate drive circuit generating gate signals for application to the gate lines; a memory performing writing and reading operations in response to predetermined control signals and synchronization signals, wherein the panel assembly comprises a normal mode and a rotated mode, wherein the number of writing operations is smaller than the number of reading operations, and wherein last-inputted data are outputted first when the panel assembly is in the rotated mode.

The reading operation may be performed for each frame and the number of writing operations may be a quarter of that of the reading operations.

The predetermined control signals and the synchronization signals may be provided from the MPU.

A synchronization signal may be a vertical synchronization signal Vsync or a signal synchronized with the vertical synchronization signal.

The gate drive circuit may be integrated on the panel assembly.

The liquid crystal display may further include a driving circuit chip provided on the panel assembly.

The gate drive circuit may generate the gate signals in response to a scanning start signal from the signal controller, and the gate signals may be sequentially scanned in an order toward the driving circuit chip.

The driving circuit chip may include the signal controller and the memory.

A liquid crystal display according to another exemplary embodiment of the present invention includes: a panel assembly provided with a plurality of pixels connected to gate lines and data lines; a signal controller generating a plurality of output control signals on the basis of image data and input control signals from an external MPU; a gate drive circuit generating gate signals for application to the gate lines; a memory performing writing and reading operations in response to predetermined control signals and a synchronization signal, wherein the panel assembly comprises a normal mode and a rotated mode, wherein the number of writing operations equals the number of reading operations, and wherein last-inputted data are outputted first when the panel assembly is in the rotated mode.

The synchronization signal may include first and second vertical synchronization signals, wherein the writing operation is synchronized with the first vertical synchronization signal and the reading operation is synchronized with the second vertical synchronization signal.

The second vertical synchronization signal may be delayed by one frame relative to the first vertical synchronization signal.

The predetermined control signals may be provided from the MPU.

The gate drive circuit may be integrated on the panel assembly.

The liquid crystal display may further include a driving circuit chip provided on the panel assembly.

The gate drive circuit may generate the gate signals in response to a scanning start signal from the signal controller, and the gate signals may be sequentially scanned in an order toward the driving circuit chip.

The driving circuit chip may include the signal controller and the memory.

A driving method of a liquid crystal display according to an exemplary embodiment of the present invention including a panel assembly provided with a plurality of pixels connected to gate lines and data lines and a memory performing writing and reading operations in response to predetermined control signals and synchronization signals, wherein the panel assembly comprises a normal mode and a rotated mode, wherein when the panel assembly is in the rotated mode, the driving method includes: writing data to the memory at a predetermined time interval; and reading the data by first outputting data inputted last at a shorter time interval than the predetermined time interval.

The liquid crystal display may further include a gate drive circuit generating gate signals for application to the gate lines, and the gate drive circuit is integrated on the panel assembly.

The driving method thereof may further include a driving circuit chip mounted on the panel assembly.

The gate signals may be sequentially scanned in an order toward the driving circuit chip.

A driving method of a liquid crystal display according to another embodiment of the present invention including a panel assembly provided with a plurality of pixels connected to gate lines and data lines and a memory performing writing and reading operations in response to predetermined control signals and synchronization signals, wherein the panel assembly comprises a normal mode and a rotated mode, wherein when the panel assembly is in the rotated mode, the driving method includes: writing data to the memory synchronized with a first synchronization signal of the synchronization signals; and reading the data by first outputting data inputted last synchronized with a second synchronization signal of the synchronization signals.

The second synchronization signal may be delayed by one frame relative to the first synchronization signal.

The liquid crystal display may further include a gate drive circuit generating gate signals for application to the gate lines, the gate drive circuit being integrated on the panel assembly.

The driving method thereof may further include a driving circuit chip mounted on the panel assembly.

The gate signals may be sequentially scanned in an order toward the driving circuit chip.

### BRIEF DESCRIPTION OF THE DRAWINGS

The present invention will become more apparent in light of the preferred embodiments described below in detail with reference to the accompanying drawings, in which:

FIG. 1 is a layout view of an LCD according to an exemplary embodiment of the present invention;

FIG. 2 is a block diagram of an LCD according to an exemplary embodiment of the present invention;

FIG. 3 is an equivalent circuit diagram of a pixel of an LCD according to an exemplary embodiment of the present invention;

FIG. 4 is a block diagram of a gate drive circuit according to an exemplary embodiment of the present invention;

FIG. 5 shows waveforms of signals used for the gate drive circuit shown in FIG. 4;

FIG. 6 is a schematic view to illustrate a scanning direction of the gate drive circuit shown in FIG. 4;

FIG. 7 shows a screen displaying an image when the main panel assembly is rotated 180 degrees;

FIGS. 8A-8C show directions of writing data, reading data, and displaying an image in a normal mode of an LCD according to an exemplary embodiment of the present invention, respectively;

FIGS. 9A-9C show directions of writing data, reading data, and displaying an image in a rotated mode of an LCD according to an exemplary embodiment of the present invention, respectively;

FIG. 10 shows a relation of input frames and output frames in a memory of an LCD according to an exemplary embodiment of the present invention;

FIG. 11 is a drawing illustrating a driving method of an LCD according to an exemplary embodiment of the present invention; and

FIG. 12 is a drawing illustrating a driving method of an LCD according to another exemplary embodiment of the present invention.

### DETAILED DESCRIPTION OF EMBODIMENTS

The present invention is described below with reference to the accompanying drawings, in which preferred embodiments of the inventions invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

An LCD and a driving method thereof according to embodiments of the present invention is described below with reference to the drawings.

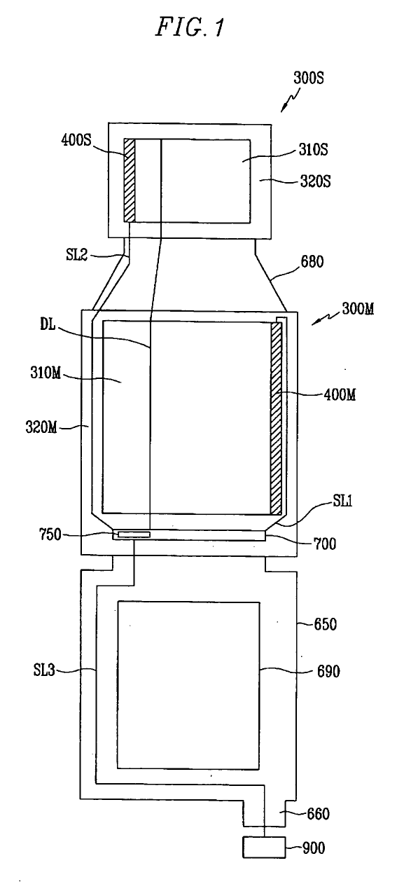

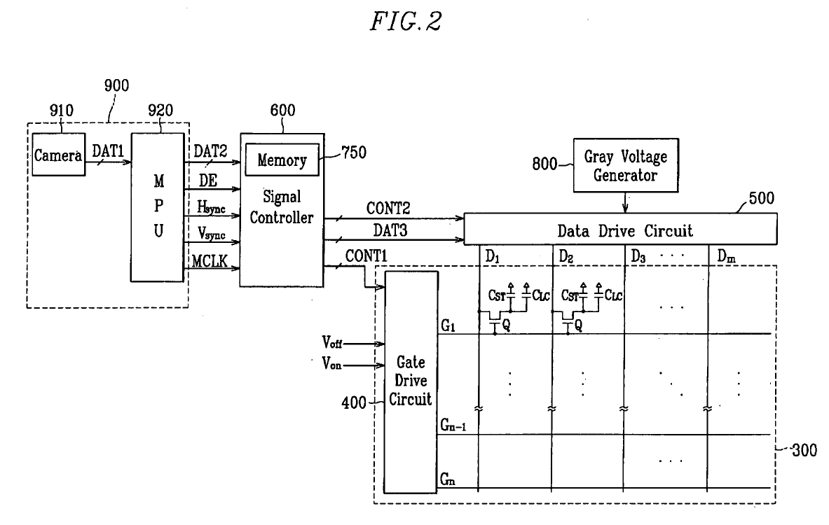

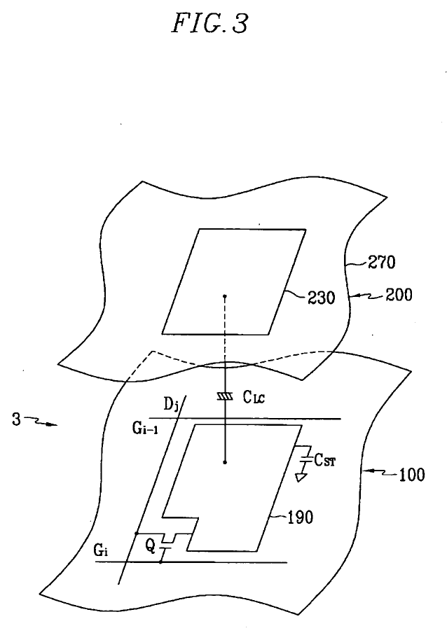

FIG. 1 is a view of an LCD according to an exemplary embodiment of the present invention; FIG. 2 is a block diagram of an LCD according to an embodiment of the present invention; and FIG. 3 is an equivalent circuit diagram of a pixel of an LCD according to an embodiment of the present invention.

Referring to FIG. 1, an LCD according to an embodiment of the present invention includes two panel assemblies of a main panel assembly 300M and a subsidiary panel assembly 300S, and an FPC 650 attached to the main panel assembly 300M, an auxiliary FPC 680 attached between the main and the subsidiary FPCs 650 and 680, and an integration chip 700 mounted on the FPC 650.

The FPC 650 is attached to one side of main panel assembly 300M and has an aperture 690 exposing the subsidiary panel assembly 300S at a folded state.

The FPC 650 has a connector 660 where signals are inputted from an external device in the lower side thereof, and a plurality of signal lines (not shown) for electrically connecting the IC 700 to the panel assemblies 300M and 300S. The signal lines form pads (not shown) in the connection points of the integration chip 700 and the attachment points of the panel assemblies 300M and 300S by substantial enlargement thereof. A signal line SL3 is connected to an external camera unit 900 to transmit a plurality of signals to the integration chip 700.

The auxiliary FPC 680 is attached between the other side of the main panel assembly 300M and one side of the subsidiary panel assembly 300S, and is provided with signal lines SL2 and DL for electrically connecting the integration chip 700 and the subsidiary panel assembly 300S.

The panel assemblies 300M and 300S include display areas 310M and 310S forming screens, and peripheral areas 320M and 320S, respectively. The peripheral areas 320M and 320S may include light-blocking layers (not shown) (“black matrix”) for blocking light. The FPCs 650 and 680 are attached to the light-blocking areas of the peripheral areas 320M and 320S.

As shown in FIG. 2, each of panel assemblies 300M and 300S includes a plurality of display signal lines including a plurality of gate lines G1-Gn and a plurality of data lines D1-Dm, a plurality of pixels connected thereto and arranged substantially in a matrix, and a gate drive circuitry 400 supplying signals to the gate lines. Most of the pixels and the display signal lines G1-Gn and D1-Dm are disposed in the display areas 310M and 310S, and the gate drive circuits 400M and 400S are located in the peripheral areas 320M and 320S. Additionally, the LCD includes a camera unit 900, a signal controller 600, a data drive circuit 500, and a gray voltage generator 800. The camera unit 900 includes a camera 910 for photographing objects and an MPU (mobile processing unit or micro processing unit) connected thereto. Signal controller 600 includes a memory 750 for storing image data.

Additionally, as shown in FIG. 1, a portion of the data lines D1-Dm are connected to the subsidiary panel assembly 300S via the auxiliary FPC 680. The two panel assemblies 300M and 300S share a portion of the data lines D1-Dm, and a line DL thereof as shown in FIG. 1.

The display signal lines G1-Gn and D1-Dm are provided on the lower panel 100 and include a plurality of gate lines G1-Gn transmitting gate signals (called scanning signals) and a plurality of data lines D1-Dm transmitting data signals. The gate lines G1-Gn extend substantially in a row direction and they are substantially parallel to each other, while the data lines D1-Dm extend substantially in a column direction and they are substantially parallel to each other.

Each pixel includes a switching element Q connected to the display signal lines G1-Gn and D1-Dm, and an LC capacitor C_{LC} and a storage capacitor C_{ST} that are connected to the switching element Q. The use of storage capacitor C_{ST} is optional.

The switching element Q such as a TFT is provided on the lower panel 100 and has three terminals: a control terminal connected to one of the gate lines G1-Gn; an input terminal connected to one of the data lines D1-Dm; and an output terminal connected to the LC capacitor C_{LC} and the storage capacitor C_{ST}.

As shown in FIG. 3, the panel assembly 300 includes the lower panel 100 and the upper panel 200 with an LC layer 3 interposed therebetween. Display signal lines G1-Gn and D1-Dm and the switching element Q are provided on the lower panel 100.

The LC capacitor C_{LC} includes a pixel electrode 190 provided on the lower panel 100, a common electrode 270 provided on the upper panel 200, and the LC layer 3 as a dielectric between the electrodes 190 and 270. The pixel electrode 190 is connected to the switching element Q, and the common electrode 270 covers the entire surface of the upper panel 100 and is supplied with a common voltage Vcom. Alternatively, both the pixel electrode 190 and the common electrode 270, which have shapes of bars or stripes, may be provided on the lower panel 100.

The storage capacitor C_{ST} functions as an auxiliary capacitor for the LC capacitor C_{LC}. The storage capacitor C_{ST} includes the pixel electrode 190 and a separate signal line (not shown), which is provided on the lower panel 100, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For a color display, each pixel uniquely represents one of three primary colors such as red, green, and blue colors (spatial division), or sequentially represents the three primary colors in time (temporal division), thereby obtaining a desired color. FIG. 3 shows an example of the spatial division in which each pixel includes a color filter 230 representing one of the three primary colors in an area of the upper panel 200 facing the pixel electrode 190. Alternatively, the color filter 230 may be provided on or under the pixel electrode 190 on the lower panel 100.

A pair of polarizers (not shown) for polarizing light are attached on outer surfaces of the lower and upper panels 100 and 200 of the panel assembly 300.

The gate drive circuits 400M and 400S synthesize the gate-on voltage Von and the gate-off voltage Voff to generate gate signals for application to the gate lines G₁-Gₙ. The gate drive circuits 400M and 400S are formed together with switching elements Q of the pixels to be integrated, and are connected to the integration chip 700 via signal lines SL1 and SL2, respectively.

The integration chip 700 is supplied with external signals via signal lines provided on the connector 660 and the FPC 650, and supplies processed signals for control of the main panel assembly 300M and the subsidiary panel assembly 300S thereto via signal lines provided on the peripheral area 320M and the auxiliary FPC 680. The IC 700 includes the gray voltage generator 800, the data drive circuit 500, and the signal controller 600 shown in FIG. 2.

A gray voltage generator 800 generates one set or two sets of gray voltages related to a transmittance of the pixels. When two sets of the gray voltages are generated, the gray voltages in one set have a positive polarity with respect to the common voltage Vcom, while the gray voltages in the other set have a negative polarity with respect to the common voltage Vcom.

The data drive circuit 500 is connected to the data lines D₁-Dₘ of the panel assembly 300, and applies data voltages selected from the gray voltages supplied from the gray voltage generator 800 to the data lines D₁-Dₘ.

The signal controller 600 controls the gate drive circuit 400 and the data drive circuit 500.

The operation of the display device is described below in detail referring to FIGS. 1 and 2.

A source for providing image data, for example, the camera 910, photographs an object for converting into image data of 8 bits DAT1 and then provides the converted data DAT1 to MPU 920. The MPU 920 reconverts the image data DAT1 of 8 bits into image data of 6 bits indicated by DAT2 for application to the signal controller 600 together with a plurality of input control signals.

The signal controller 600 is supplied with image signals DAT2 and input control signals controlling the display of the image signals DAT2 from the MPU 920. The input control signals include, for example, a vertical synchronization signal Vsync, a horizontal synchronization signal Hsync, a main clock MCLK, and a data enable signal DE. After generating gate control signals CONT1, data control signals CONT2 and switching control signals CONT3 and processing the image signals DAT2 to be suitable for the operation of the panel assemblies 300M and 300S in response to the input control signals, the signal controller 600 provides the gate control signals CONT1 to the gate drive circuits 400M and 400S, and the processed image signals DAT3 and the data control signals CONT2 to the data drive circuit 500.

The gate control signals CONT1 include a vertical synchronization start signal STV for informing the gate drive circuit of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data drive circuit 500 of a start of a horizontal period, a load signal LOAD or TP for instructing the data drive circuit 500 to apply the appropriate data voltages to the data lines D₁-Dₘ, a data clock signal HCLK, and an inversion control signal RVS for reversing the polarity of the data voltages (with respect to the common voltage Vcom).

The data drive circuit 500 receives the processed image signals DAT3 for a pixel row from the signal controller 600, and converts the processed image signals DAT3 into the analogue data voltages selected from the gray voltages supplied from the gray voltage generator 800 in response to the data control signals CONT2 from the signal controller 600.

Responsive to the gate control signals CONT1 from the signal controller 600, the gate drive circuits 400M and 400S apply the gate-on voltage Von to the gate lines G₁-Gₙ, thereby turning on the switching elements Q connected to the gate lines G₁-Gₙ.

The data drive circuit 500 applies the data voltages to corresponding data lines D₁-Dₘ for a turn-on time of the switching elements Q (which is called “one horizontal period” or “1H” and equals one period of the horizontal synchronization signal Hsync, the data enable signal DE, and the gate clock signal CPV). The data voltages in turn are supplied to corresponding pixels via the turned-on switching elements Q.

The difference between the data voltage and the common voltage Vcom applied to a pixel is expressed as a charged voltage of the LC capacitor C_{LC}, i.e., a pixel voltage. The liquid crystal molecules have orientations depending on a magnitude of the pixel voltage, and the orientations determine a polarization of light passing through the LC capacitor C_{LC}. The polarizers convert light polarization into light transmittance.

By repeating the above-described procedure, all gate lines G₁-Gₙ are sequentially supplied with the gate-on voltage Von during a frame, thereby applying the data voltages to all pixels. When a next frame starts after finishing one frame, the inversion control signal RVS applied to the data drive circuit 500 is controlled such that a polarity of the data voltages is reversed (“frame inversion”). The inversion control signal RVS may be controlled such that the polarity of the data voltages flowing in a data line in one frame is reversed (e.g.: “row inversion”, “dot inversion”), or the polarity of the data voltages in one packet is reversed (e.g.: “column inversion”, “dot inversion”).

A gate drive circuit according to an exemplary embodiment of the present invention is described below.

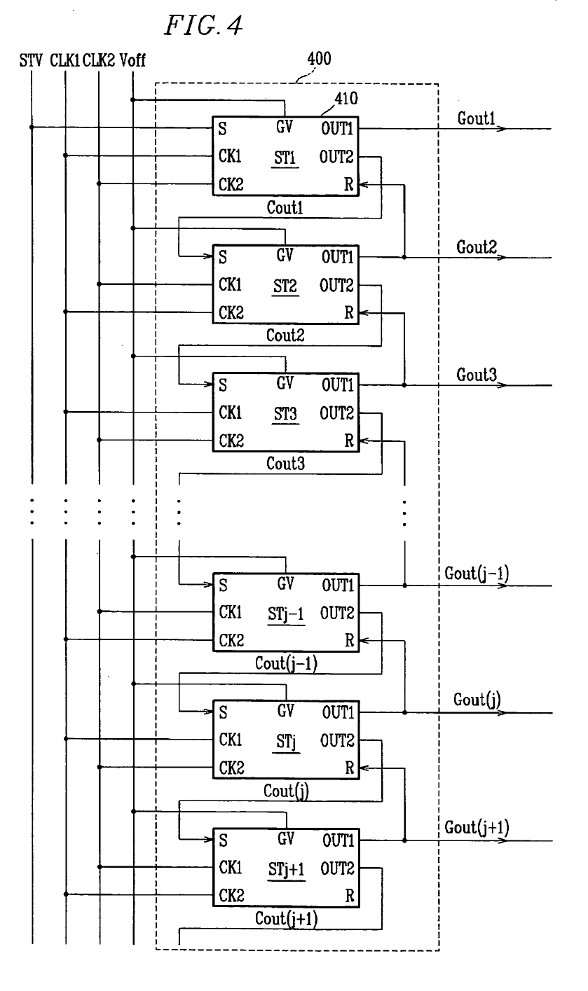

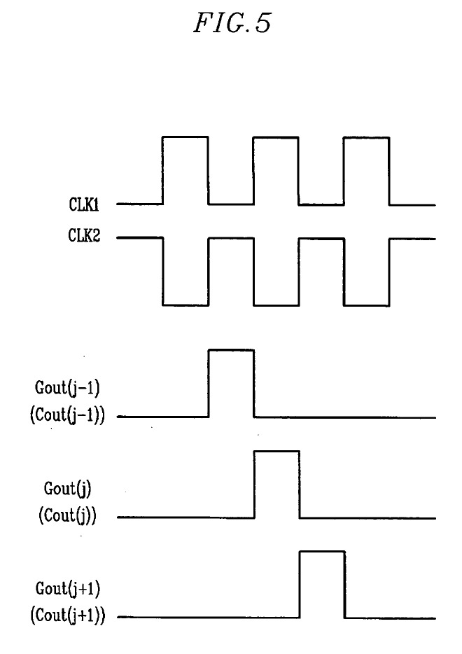

FIG. 4 is a block diagram of a gate drive circuit according to an exemplary embodiment of the present invention, and FIG. 5 shows waveforms of signals of the gate drive circuit shown in FIG. 4. FIG. 6 shows a direction of application of gate signals in the main panel assembly shown in FIG. 1.

Referring to FIG. 4, a gate drive circuit 400 is a shift register including a plurality of stages 410 arranged in a line and connected to the gate lines G₁-Gₙ. The gate drive circuit 400 is applied with a scanning start signal STV, a gate-off voltage V_{off}, and clock signals CLK1 and CLK2.

Each of the stages 410 includes a set terminal S, a gate voltage terminal GV, a pair of clock terminals CK1 and CK2, a reset terminal R, a gate output terminal OUT1, and a carry output terminal OUT2.

Each of the stages 410, for example the set terminal S of the j-th stage STⱼ, is supplied with a carry output of a previous stage STⱼ₋₁, i.e., a previous carry output, and the reset terminal thereof is supplied with a gate output of a next stage STⱼ₊₁, i.e., a next gate output Gout(j+1). The clock terminals CK1 and CK2 thereof receive the clock signals CLK1 and CLK2, respectively, the gate voltage terminal GV receives the gate-off voltage V_{off}, and the frame reset terminal FR receives the initializing signal INT. The gate output terminal OUT1 outputs a gate output Gout(j), and the carry output terminal OUT2 outputs a carry output Cout(j).

However, the S terminal of an initial stage ST1 of the left shift register 400 is supplied with the vertical synchronization start signal STV instead of the previous gate output. Additionally, when the clock terminals CK1 and CK2 of the j-th stage receive the clock signal CLK1 and CLK2, respectively, the clock terminals CK1 of the (j−1)-th stage STⱼ₋₁ and the (j+1)-th stage STⱼ₊₁ receive the clock signal CLK2, and the clock terminals CK2 thereof receive the clock signal CLK1.

Each clock signal CLK1 and CLK2 is preferably the gate-on voltage Vₒₙ for a high interval and is the gate-off voltage for a low interval in order to drive the switching elements Q of the pixels. As shown in FIG. 5, the duty ratio and the phase difference of the clock signals CLK1 and CLK2 may be 50% and 180 degrees, respectively.

In this way, each stage 410 generates the carry signal Cout(j) and the gate output Gout(j) synchronized with the clock signals CLK1 and CLK2 based on the previous carry signal Cout(j−1) and the next gate output Gout(j+1).

As shown in FIG. 6, the scanning start signal STV is applied to the first stage ST1 from the integration chip 700 and then the gate signals are applied to the gate lines G1-Gn in an order toward the integration chip 700.

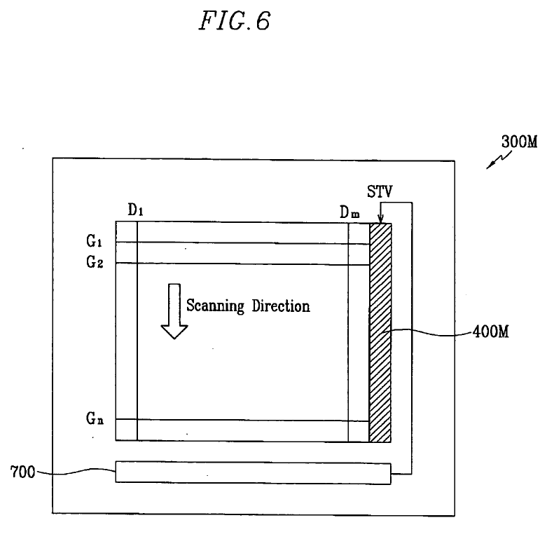

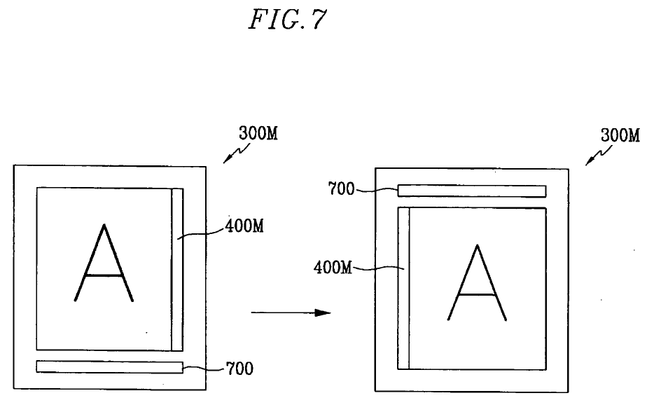

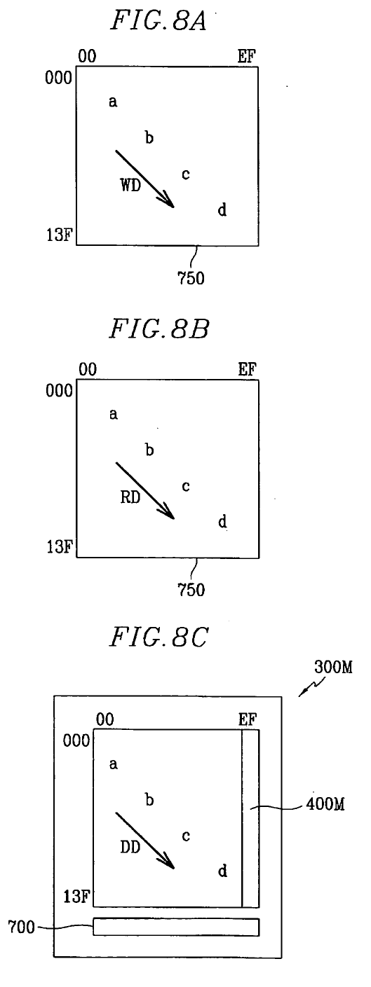

FIG. 7 shows exemplary images when the main panel assembly 300M is not rotated (normal mode) and when the main panel assembly 300M is rotated (rotated mode), and the left image corresponds to the normal mode and the right corresponds to the rotated mode. In this case, an original image must be displayed in the rotated mode as in the normal mode, and this will be described with reference to FIGS. 8A to 12.

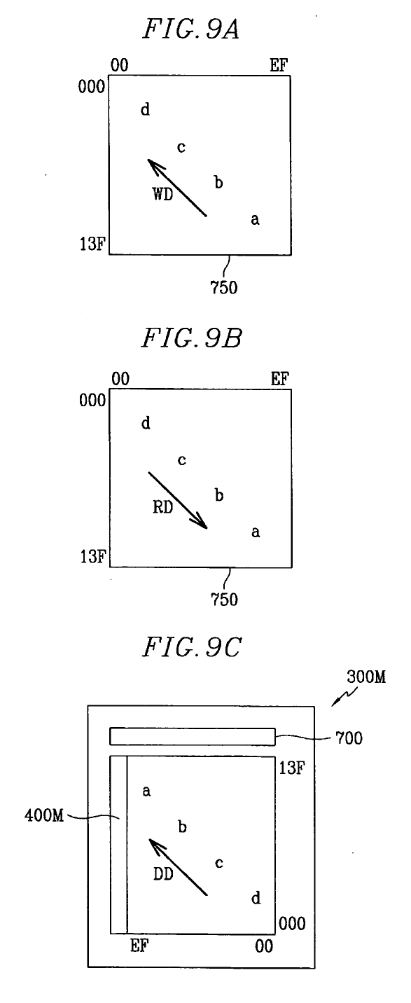

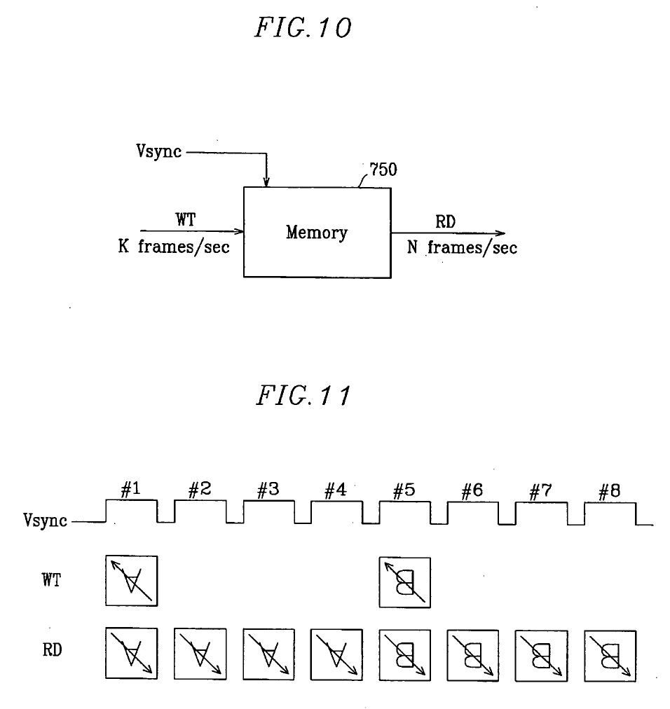

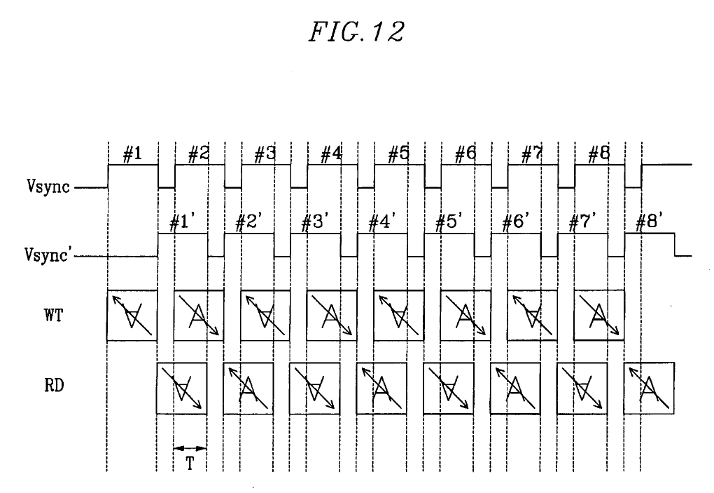

FIGS. 8A-8C show directions of writing data, reading data, and displaying an image in a normal mode, respectively, of an LCD according to an exemplary embodiment of the present invention; and FIGS. 9A-9C show directions of writing data, reading data, and displaying an image, respectively, in a rotated mode of an LCD according to an exemplary embodiment of the present invention. FIG. 10 shows the relationship of input frames and output frames in a memory of an LCD according to an exemplary embodiment of the present invention, and FIG. 11 is a drawing illustrating a driving method of an LCD according to an exemplary embodiment of the present invention.

For descriptive convenience, the memory 750 is shown to be suitable for the main panel assembly 300M, and ‘00’, ‘EF’, ‘000’, and ‘13F’ represent a hexadecimal number and a resolution of the main panel assembly 300M is 240×320.

Additionally, as shown in FIGS. 8A and 9A, writing data to the memory 750 is bidirectional, that is, the top-left to bottom-right and the bottom-right to top-left, but reading data from the memory 750 is unidirectional, that is, the top-left to bottom-right. This is in consideration of an address counter set as [00,000] that determines the writing direction. Of course, alternatively, the address counter may be set as [EF, 13F], and the writing direction is the bottom-right to top-left in such case.

At first, as shown in FIG. 8A, the writing direction WD is from the top-left, i.e., [00, 000] to the bottom-right, i.e., [EF, 13F], and the reading direction RD is also identical to the writing direction WD as shown in FIG. 8B. Additionally, a display direction DD is also identical to the reading direction DD and thus the original image is displayed possible to be readable.

Alternatively, as shown in FIG. 9A, when the writing direction WD is from the bottom-right to top-left and the reading direction RD is from the top-left to bottom-right opposite the writing direction WD, the original image can be displayed even in the rotated mode as shown in FIG. 9C. In this way, the writing direction WD and the reading direction RD are opposite each other, and the original image can be displayed even in the rotated mode.

To summarize, data are read in a first-in first-out method in which first inputted data are outputted first in the normal mode, and data are read in a last-in first-out method in which last inputted data are outputted first in the rotated mode.

A writing operation WT of inputting data to the memory 750 and a reading operation RD of outputting data from the memory 750 are shown as a unit of a frame in FIG. 10. In other words, writing is performed at the speed of K frames per second, and reading is performed at the speed of N frames per second. The magnitude of K is the same as or smaller than the magnitude of N.

Referring to FIG. 11, writing and reading of data are performed in synchronization with, for example, the vertical synchronization signal Vsync.

The high values of the vertical synchronization signal Vsync correspond to the time for a frame, and first to eighth frames #1-#8 are shown in FIG. 11.

The writing operation WT occurs at one-fourth the rate of the reading operation RD. In other words, writing is performed once in four frames and reading is performed for each frame. Thus, N=4K. Or stated differently, the ratio of write operations to read operations is one-fourth. Since the writing direction WD is the bottom-right to top-left, data reversing the original image data are inputted to the memory 750. When the data are read in a direction opposite to the writing direction WD, the original image can be displayed upright in the rotated mode. Alternatively, the writing direction WD may be the top-left to bottom-right and the reading direction RD may be the bottom-right to top-left.

Occasionally, there is a collision of data, that is, the writing direction WD and the reading direction RD are opposite each other and thereby writing and reading occur concurrently. In these situations, the original image may look broken on a screen. However, since the collision of data does not occur for each frame, but rather for every fourth frame, the broken-image phenomenon is invisible to the human eye.

FIG. 12 shows a driving method of an LCD according to another exemplary embodiment of the present invention.

Referring to FIG. 12, a second vertical synchronization signal Vsync′ delayed by a frame relative to a first vertical synchronization signal Vsync is shown therein, and a writing operation WT and a reading operation RD are the same as N=K. However, the writing operation WD is performed synchronized with the first vertical synchronization signal Vsync and the reading operation RD is performed synchronized with the second vertical synchronization signal Vsync′.

For example, as shown in FIG. 12, the writing operation WT of data for the first frame #1 is performed in the direction of the bottom-right to top-left in the high interval of the first vertical synchronization signal Vsync. After one frame has elapsed, the reading operation RD of the data for the first frame #1′ in the high interval of the second vertical synchronization signal Vsync′ is performed in the direction of the top-left to bottom-right. Subsequently, the writing operation WT of data for the second frame #2 begins in the direction of the top-left to bottom-right in the high interval of the first vertical synchronization signal Vsync after a short time, that is, a blank interval of the first vertical synchronization signal Vsync. Thus, the writing operation WT and the reading operation RD are performed at the same time during the time T.

However, collision of data does not occur due to a time difference corresponding to the blank interval.

In detail, both the writing operation WT and the reading operation RD are performed by hanging the writing and reading directions for each frame unlike in FIG. 11, and the reading operation RD is performed after the writing operation WT is completed and thus collision of data does not occur. Additionally, during the time T when the writing operation WT and the reading operation RD are performed at the same time, the writing operation WT begins some time after start of the reading operation RD, that is, after the blank interval, and thus collision of data does not occur.

Although not shown in the figures, memory 750 may be operated using a write enable signal WE, a read enable signal RE, and an address counter signal AC.

In this way, the original image can be implemented like the normal mode in the rotated mode in the LCD provided with the integrated gate drive circuits 400M and 400S.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A liquid crystal display comprising:
a panel assembly operable in a rotated mode, the panel assembly including a plurality of pixels connected to gate lines and data lines;
a signal controller generating a plurality of output control signals on the basis of image data and in put control signals from an external source;
a gate drive circuit generating gate signals for application to the gate lines; and
a memory performing writing and reading operations in response to predetermined control signals and synchronization signals, wherein when the panel assembly is operated in the rotated mode a ratio of the number of writing operations to the number of reading operations is less than one, and further wherein data are read in an inverse order of receipt.

2. The liquid crystal display of claim 1, wherein the liquid crystal display operates on a frame by frame basis, and further wherein the liquid crystal display is configured to perform reading and writing operations and the reading operations are performed for each frame, and the ratio of writing operations to reading operations is one-fourth.

3. The liquid crystal display of claim 1, wherein the liquid crystal display further comprises a microprocessor and the microprocessor provides the predetermined control signals and the synchronization signals.

4. The liquid crystal display of claim 1, wherein the synchronization signals comprise a first vertical synchronization signal or a second vertical synchronization signal synchronized with the first vertical synchronization signal.

5. The liquid crystal display of claim 1, wherein the gate drive circuit is integrated on the panel assembly.

6. The liquid crystal display of claim 1, further comprising a data drive circuit chip included on the panel assembly.

7. The liquid crystal display of claim 6, wherein the gate drive circuit generates the gate signals in response to a scanning start signal from the signal controller, and the gate signals are sequentially scanned in an order toward the data drive circuit chip.

8. The liquid crystal display of claim 6, wherein the data drive circuit chip comprises the signal controller and the memory.

9. A liquid crystal display comprising:
a panel assembly operable in a rotated mode, the panel assembly including a plurality of pixels connected to gate lines and data lines;
a signal controller generating a plurality of output control signals on the basis of image data and input control signals from an external source;
a gate drive circuit generating gate signals for application to the gate lines; and
a memory performing writing and reading operations in response to predetermined control signals and a synchronization signal, wherein a ratio of the number of writing operations to the number of reading operations is less than one, and further wherein data are read in an inverse order of receipt.

10. The liquid crystal display of claim 9, wherein the synchronization signal comprises first and second vertical synchronization signals,
wherein the writing operation is performed synchronized with the first vertical synchronization signal and the reading operation is performed synchronized with the second vertical synchronization signal.

11. The liquid crystal display of claim 10, wherein the second vertical synchronization signal is delayed by one frame relative to the first vertical synchronization signal.

12. The liquid crystal display of claim 9, wherein the liquid crystal display further comprises a microprocessor and the microprocessor provides the predetermined control signals.

13. The liquid crystal display of claim 9, wherein the gate drive circuit is integrated on the panel assembly.

14. The liquid crystal display of claim 9, further comprising a data drive circuit chip included on the panel assembly.

15. The liquid crystal display of claim 14, wherein the gate drive circuit generates the gate signals in response to a scanning start signal from the signal controller, and the gate signals are sequentially scanned in an order toward the data drive circuit chip.

16. The liquid crystal display of claim 14, wherein the data drive circuit chip comprises the signal controller and the memory.

17. A driving method of a liquid crystal display comprising a panel assembly provided with a plurality of pixels connected to gate lines and data lines and a memory performing writing and reading operations in response to predetermined control signals and synchronization signals, wherein the panel assembly is operable in a normal mode and a rotated mode, and wherein when the panel assembly is operable in a rotated mode,
the driving method comprises:
writing data to the memory at a predetermined time interval; and
reading the data by first outputting data inputted last at a shorter time interval than in the predetermined time interval.

18. The driving method thereof of claim 17, wherein the liquid crystal display further comprises a gate drive circuit generating gate signals for application to the gate lines, and the gate drive circuit is integrated on the panel assembly.

19. The driving method thereof of claim 17, further comprising a data drive circuit chip mounted on the panel assembly.

20. The driving method thereof of claim 19, wherein the gate signals are sequentially scanned in an order toward the driving circuit chip.

21. A driving method of a liquid crystal display comprising a panel assembly provided with a plurality of pixels connected to gate lines and data lines and a memory performing writing and reading operations in response to predetermined control signals and synchronization signals, wherein the panel assembly is operable in a normal mode and a rotated mode, wherein when the panel assembly is in the rotated mode,
the driving method thereof comprises:
writing data to the memory synchronized with a first synchronization signal of the synchronization signals; and
reading the data by first outputting data inputted last synchronized with a second synchronization signal of the synchronization signals.

22. The driving method thereof of claim 21, wherein the second synchronization signal is delayed by one frame relative to the first synchronization signal.

23. The driving method of claim 21, wherein the liquid crystal display further comprises a gate drive circuit generating gate signals for application to the gate lines, and the gate drive circuit is integrated on the panel assembly.

24. The driving method of claim 21, further comprising a data drive circuit chip mounted on the panel assembly.

25. The driving method of claim 24, wherein the gate signals are sequentially scanned in an order toward the data drive circuit chip.
